(19) United States
(12) Patent Application Publication
(10) Pub. No.: US 2024/0347935 A1
(43) Pub. Date: Oct. 17, 2024

(54) CRIMP TERMINAL AND METHOD FOR MANUFACTURING TERMINAL-EQUIPPED WIRE

(71) Applicant: Yazaki Corporation, Tokyo (JP)

(72) Inventor: Naoki ITO, Shizuoka (JP)

(73) Assignee: Yazaki Corporation, Tokyo (JP)

(21) Appl. No.: 18/631,542

(22) Filed: Apr. 10, 2024

(30) Foreign Application Priority Data
Apr. 17, 2023 (JP) 2023-067037

(51) Int. Cl. H01R 4/18; H01R 11/12; H01R 43/048

(52) U.S. Cl. CPC H01R 4/185; H01R 11/12; H01R 43/048

(57) ABSTRACT

A crimp terminal includes: a bottom plate on which a wire is disposed; a conductor crimp portion formed in the bottom plate and to which a conductor of the wire is crimped; and an insulator crimp portion formed in a portion which is rearward of the conductor crimp portion in the bottom plate and to which an insulator of the wire is crimped. The insulator crimp portion includes a pair of crimp pieces projecting outward in a width direction from both side edges in the width direction of the bottom plate, and front end edges of the crimp pieces are inclined backward with respect to a direction orthogonal to a front-rear direction of the bottom plate.

### CROSS-REFERENCE TO RELATED APPLICATIONS

The present application is based on, and claims priority from Japanese Patent Application No. 2023-067037, filed on Apr. 17, 2023, the entire contents of which are incorporated herein by reference.

### TECHNICAL FIELD

The present disclosure relates to a crimp terminal and a method for manufacturing a terminal-equipped wire.

### BACKGROUND

A generally-known crimp terminal (connection terminal) crimped and connected to a wire has a conductor crimp portion which is crimped to a conductor of the wire exposed at the end of the wire by means of swaging, and an insulator crimp portion which is crimped to an insulator of the wire covering the conductor by means of swaging (see JP2008-226671A). The conductor crimp portion has, for example, a bottom plate, and plate-like conductor crimp pieces which are positioned on both sides of the bottom plate in a direction orthogonal to the extending direction of the wire and extend from the bottom plate. In a state in which the conductor of the wire is disposed on the bottom plate, the conductor crimp portion is crimped to the conductor by swaging the conductor crimp portion using the conductor crimp pieces positioned on both sides of the bottom plate so as to cover the conductor. Meanwhile, the insulator crimp portion has, for example, a bottom plate, and plate-like insulator crimp pieces which are positioned on both sides of the bottom plate in a direction orthogonal to the extending direction of the wire and extend from the bottom plate. In a state in which the insulator of the wire is disposed on the bottom plate, the insulator crimp portion is crimped to the insulator by swaging the insulator crimp portion using the insulator crimp pieces positioned on both sides of the bottom plate so as to cover the insulator.

### SUMMARY OF THE INVENTION

In the crimp terminal described above, the front end edges of the insulator crimp pieces are generally almost orthogonal to the extending direction of the bottom plate, and the rear end edges of the insulator crimp pieces are inclined forward to the direction orthogonal to the extending direction of the bottom plate. In the crimp terminal in which the elongation of the crimp terminal (bottom plate) is large when the crimp terminal is crimped to the wire, the insulator crimp pieces are greatly inclined on the side of the conductor crimp portion, and the insulator of the wire is also closer to the side of the conductor crimp portion than expected, and thus there is a possibility that the insulator of the wire is caught in the conductor crimp portion.

An object of the present disclosure is to provide a crimp terminal and a method for manufacturing a terminal-equipped wire capable of suppressing an inclination of the insulator crimp pieces toward the conductor crimp portion side when the crimp terminal is crimped to the wire.

A crimp terminal according to the present embodiment includes: a plate-like terminal body on which a wire is disposed; a conductor crimp portion formed in the terminal body and to which a conductor of the wire is crimped; and an insulator crimp portion formed in a portion which is rearward of the conductor crimp portion in the terminal body and to which an insulator of the wire is crimped, in which the insulator crimp portion includes a pair of crimp pieces projecting outward in a width direction from both side edges in the width direction of the terminal body, and front end edges of the crimp pieces are inclined backward in a direction orthogonal to a front-rear direction of the terminal body.

A method for manufacturing a terminal-equipped wire according to the present embodiment includes: disposing a wire in a crimp terminal, the wire including: a conductor; and an insulator covering the conductor in a state in which a front end of the conductor is exposed, and the crimp terminal including: a plate-like terminal body; a conductor crimp portion formed in the terminal body and to which the exposed conductor is crimped; and an insulator crimp portion formed in a portion which is rearward of the conductor crimp portion in the terminal body and to which a front end of the insulator is crimped; and crimping the conductor crimp portion to the exposed conductor and crimping the insulator crimp portion to the front end of the insulator, in which the insulator crimp portion includes a pair of crimp pieces projecting outward in a width direction from both side edges in the width direction of the terminal body in a state before crimping the insulator crimp portion to the insulator, and front end edges of the crimp pieces are inclined backward with respect to a direction orthogonal to an extending direction of the wire in a state before crimping the insulator crimp portion to the insulator.

The above configuration makes it possible to provide a crimp terminal and a method for manufacturing a terminal-equipped wire capable of suppressing an inclination of the insulator crimp pieces toward the conductor crimp portion side when the crimp terminal is crimped to the wire.

### BRIEF DESCRIPTION OF DRAWINGS

FIG. 1 is a perspective view illustrating an example of a crimp terminal according to a present embodiment.

FIG. 2 is a plan view illustrating an example of the crimp terminal according to the present embodiment.

FIG. 3 is a side view illustrating an example of the crimp terminal according to the present embodiment.

FIG. 4 is a developed view of the crimp terminal.

FIG. 5 is a plan view illustrating an example of a terminal-equipped wire according to the present embodiment.

FIG. 6 is a side view illustrating an example of the terminal-equipped wire according to the present embodiment.

FIG. 7 is a cross-sectional view taken along A-A line of FIG. 5.

FIG. 8 is a cross-sectional view taken along B-B line of FIG. 5.

FIG. 9 is a side view explaining a crimping step.

FIG. 10 is a cross-sectional view of a conductor crimp portion explaining the crimping step.

FIG. 11 is a cross-sectional view of the conductor crimp portion explaining the crimping step.

FIG. 12 is a cross-sectional view of an insulator crimp portion explaining the crimping step.

FIG. 13 is a cross-sectional view of the insulator crimp portion explaining the crimping step.

### DETAILED DESCRIPTION OF THE INVENTION

Hereinafter, a crimp terminal and a method for manufacturing a terminal-equipped wire according to a present embodiment will be described in detail with reference to the drawings. Note that the dimensional ratio of the drawings is exaggerated for the sake of explanation, and may differ from the actual ratio.

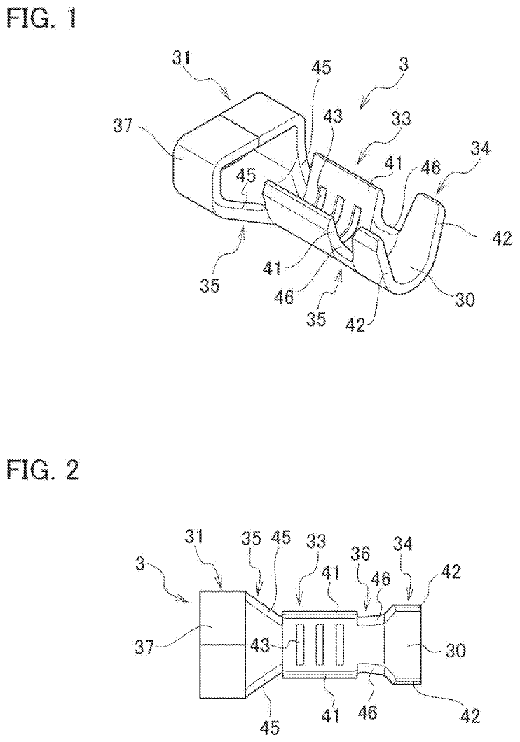

As illustrated in FIGS. 1 to 4, a crimp terminal 3 is a terminal (connection terminal) crimped and connected to a wire 2 which will be described later. The crimp terminal 3 has a bottom plate 30 formed of a metal material (plate-like terminal body). In the bottom plate 30, an electric connection portion 31, a conductor crimp portion 33, and an insulator crimp portion 34 are formed in the front-rear direction of the crimp terminal 3, or from one end side to the other end side in the extending direction of the wire 2 to which the crimp terminal 3 is crimped. Further, a first joint 35 that joints the space between the electric connection portion 31 and the conductor crimp portion 33 is formed between the electric connection portion 31 and the conductor crimp portion 33. Furthermore, a second joint 36 that joints the space between the conductor crimp portion 33 and the insulator crimp portion 34 is formed between the conductor crimp portion 33 and the insulator crimp portion 34.

The electric connection portion 31 is a portion that is connected to a mating terminal, such as another component (not illustrated). The electrical connection portion 31 of the present embodiment has a box portion 37 formed in a box shape; however, the electric connection portion 31 is not limited to this structure. For example, the electric connection portion 31 may have a bolt insertion hole formed in the bottom plate 30.

The conductor crimp portion 33 is a portion that is crimped to a conductor 21 of the wire 2 to which the crimp terminal 3 is crimped, and the insulator crimp portion 34 is a portion that is crimped to an insulator 22 of the wire 2 to which the crimp terminal 3 is crimped.

That is, at the position of the conductor crimp portion 33 of the bottom plate 30, a pair of conductor crimp pieces 41 and 41 which are crimped to the conductor 21 of the wire 2 are formed so as to project outward. The pair of conductor crimp pieces 41 and 41 extend from both side edges of the bottom plate 30 in a direction intersecting with the extending direction of the wire 2. Before being crimped to the wire 2, the bottom plate 30 and the pair of conductor crimp pieces 41 and 41 are formed in a substantially U-shape when viewed from the extending direction of the wire 2 (see FIG. 1). Further, at the position of the conductor crimp portion 33 of the bottom plate 30, serrations 43 extending in a groove shape over the bottom plate 30 and the pair of conductor crimp pieces 41 and 41 are formed along the direction intersecting with the extending direction of the wire 2. In the present embodiment, three serrations 43 are formed side by side in the extending direction of the wire 2 that is crimped at the conductor crimp portion 33.

Meanwhile, at the position of the insulator crimp portion 34 of the bottom plate 30, a pair of insulator crimp pieces 42 and 42 which are crimped to the insulator 22 of the wire 2 are formed so as to project outward. The pair of pair of insulator crimp pieces 42 and 42 extend from both side edges of the bottom plate 30 in a direction intersecting with the extending direction of the wire 2. Before being crimped to the wire 2, the bottom plate 30 and the pair of insulator crimp pieces 42 and 42 are formed in a substantially U-shape when viewed from the extending direction of the wire 2 (see FIG. 1).

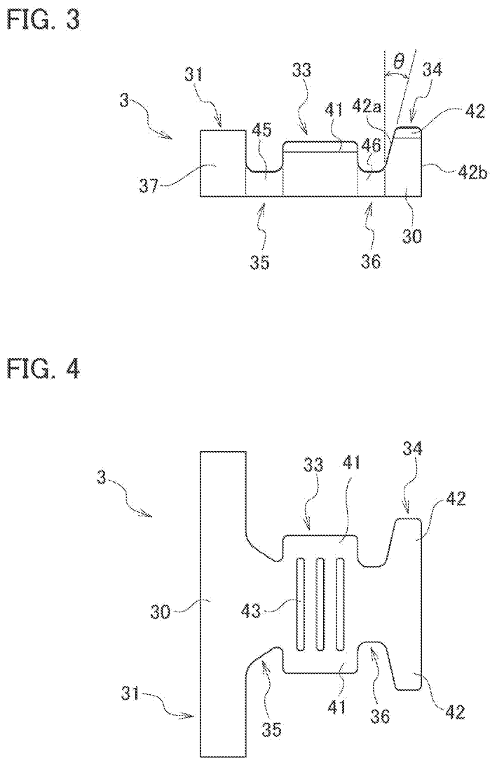

In the present embodiment, front end edges 42a of the insulator crimp pieces 42 are inclined backward with respect to a direction (up-down direction) orthogonal to the extending direction of the wire 2 in a state before crimping the insulator crimp portion 34 to the insulator 22 of the wire 2. That is, the front end edges 42a of the insulator crimp pieces 42 are formed in a tapered shape (inclined shape) which is inclined toward the rear end edge 42b side (backward) with respect to the bottom plate 30. For example, the inclination angle θ of the front end edges 42a is 15 degrees (see FIG. 3).

Meanwhile, in the present embodiment, the rear end edges 42b of the insulator crimp pieces 42 are substantially orthogonal to the extending direction of the wire 2 in a state before crimping the insulator crimp portion 34 to the insulator 22; however, the structure is not limited thereto. For example, the rear end edges 42b of the insulator crimp pieces 42 may be formed in a tapered shape (inclined shape) which is slightly inclined to the opposite side of the front end edge 42a side (backward) with respect to the bottom plate 30.

The first joint 35 is configured to include the bottom plate 30 and a pair of first side plates 45 and 45, and the first side plates 45 joint the rear end edge of the electric connection portion 31 and the front end edges of the conductor crimp pieces 41. Meanwhile, the second joint 36 is configured to include the bottom plate 30 and a pair of second side plates 46 and 46, and the second side plates 46 joint the rear end edges of the conductor crimp pieces 41 and the front end edges 42a of the insulator crimp pieces 42.

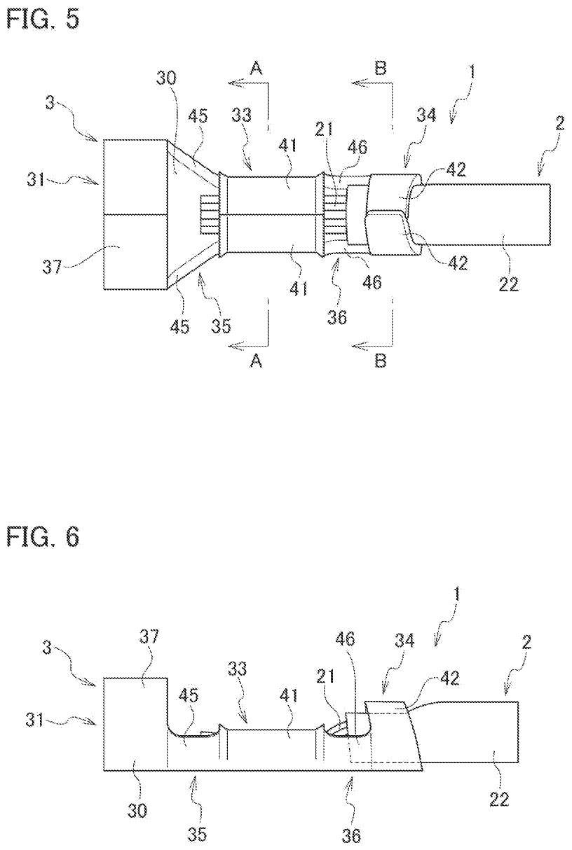

As illustrated in FIGS. 5 to 8, the terminal-equipped wire 1 includes the wire 2 and the crimp terminal 3. The crimp terminal 3 is electrically connected to a mating terminal (not illustrated) or the like in a state in which it is integrally connected to the wire 2. In the wire 2 to which the crimp terminal 3 is crimped, the insulator 22 is removed at the end, and the conductor 21 is exposed for a predetermined length. The conductor 21 of the present embodiment is an aggregate of a plurality of elementary wires. The conductor 21 is formed of a conductive metal material such as copper or aluminum, and the insulator 22 is formed of an insulating coating material. The crimp terminal 3 is crimped to the end of the wire 2, thereby being electrically connected to the exposed conductor 21.

An example of a method for manufacturing the terminal-equipped wire 1 will be described below.

The method for manufacturing the terminal-equipped wire 1 according to the present embodiment includes at least a disposing step and a crimping step.

First, the disposing step will be described.

The disposing step is a step of disposing the wire 2 in the crimp terminal 3. As described above, the wire 2 has the conductor 21, and the insulator 22 for covering the conductor 21 in a state in which the front end of the conductor 21 is exposed. Meanwhile, the crimp terminal 3 has the bottom plate 30, the conductor crimp portion 33 which is formed on the bottom plate 30 and to which the exposed conductor 21 is crimped, and the insulator crimp portion 34 formed in a portion which is rearward of the conductor crimp portion 33 in the bottom plate 30 and to which the front end of the insulator 22 is crimped. In the disposing step, the wire 2 is disposed in the crimp terminal 3.

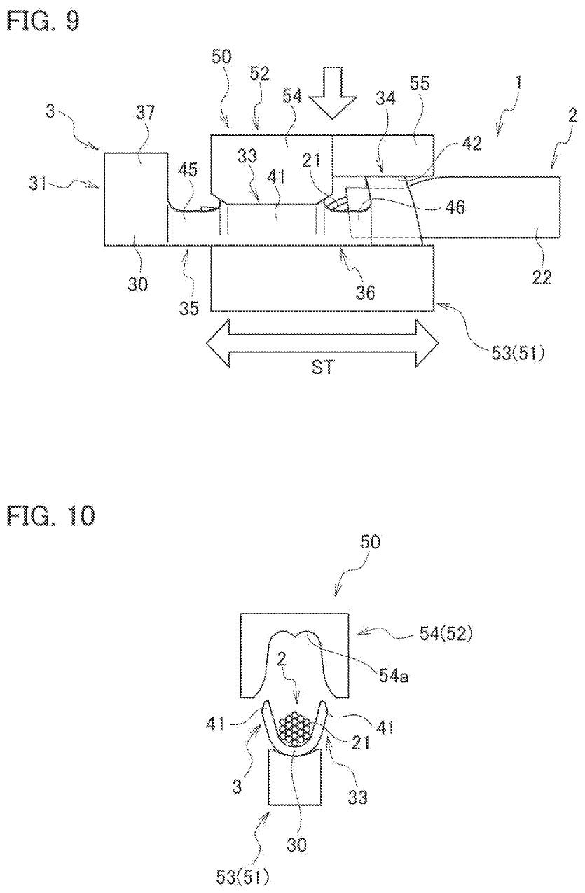

In the disposing step, the wire 2 and the crimp terminal 3 are disposed in a first mold 51 of a terminal crimp device 50. As illustrated in FIGS. 9, 10 and 12, the terminal crimp device 50 has the first mold 51 and a second mold 52. The first mold 51 is a fixed mold, and supports the crimp terminal 3. The second mold 52 is a movable mold, and moves relatively in the up-down direction with respect to the first mold 51.

As illustrated in FIG. 9, the first mold 51 has an anvil 53. The anvil 53 supports the conductor crimp portion 33 and the insulator crimp portion 34 of the crimp terminal 3.

The second mold 52 has a first crimper 54 (conductor crimper) and a second crimper 55 (insulator crimper). The first crimper 54 and the second crimper 55 are disposed so as to face the anvil 53. The first crimper 54 swages the conductor crimp pieces 41, thereby crimping the conductor crimp portion 33 to the conductor 21. The second crimper 55 swages the insulator crimp portion 34, thereby crimping the insulator crimp portion 34 to the insulator 22.

In the disposing step, the crimp terminal 3 formed in a substantially U-shape is disposed on the upper surface of the first mold 51. The crimp terminal 3 is disposed on the upper surface of the first mold 51 such that the conductor crimp portion 33 and the insulator crimp portion 34 face the anvil 53 of the first mold 51. More specifically, the crimp terminal 3 is disposed such that the bottom plate 30 on which the conductor crimp portion 33 is formed is supported by the anvil 53, and such that the tip ends of the pair of conductor crimp pieces 41 and 41 face the first crimper 54 of the second mold 52. Further, the crimp terminal 3 is disposed such that the bottom plate 30 on which the insulator crimp portion 34 is formed is supported by the anvil 53, and such that the tip ends of the pair of insulator crimp pieces 42 and 42 face the second crimper 55 of the second mold 52.

The wire 2 is disposed in the crimp terminal 3 supported by the first mold 51. The wire 2 is disposed in the crimp terminal 3 such that the exposed conductor 21 faces the bottom of the conductor crimp portion 33, and such that the front end of the insulator 22 faces the bottom of the insulator crimp portion 34.

Next, the crimping step will be described.

The crimping step is a step of crimping the conductor crimp portion 33 of the crimp terminal 3 to the conductor 21 of the wire 2, and crimping the insulator crimp portion 34 of the crimp terminal 3 to the insulator 22 of the wire 2. That is, in the crimping step, the conductor crimp portion 33 is crimped to the conductor 21, and the insulator crimp portion 34 is crimped to the insulator 22. In the crimping step, the wire 2 and the crimp terminal 3 are sandwiched between the first mold 51 and the second mold 52. The conductor crimp pieces 41 are swaged and crimped to the conductor 21 by the first mold 51 and the second mold 52, and the insulator crimp pieces 42 are swaged and crimped to the insulator 22 by the first mold 51 and the second mold 52. In the crimping step, the second mold 52 moves downward toward the first mold 51.

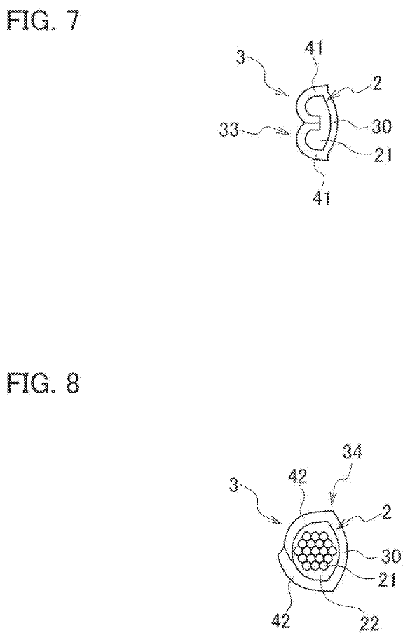

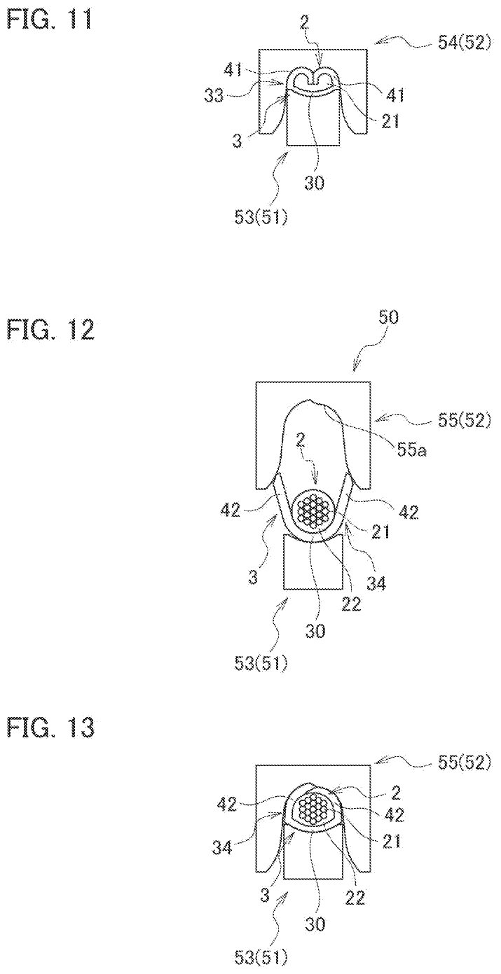

As illustrated in FIG. 10, the first crimper 54 has a curved surface 54a that deforms the pair of conductor crimp pieces 41 and 41. The conductor crimp portion 33 of the present embodiment is crimped to the conductor 21 in a manner called B-crimp (see FIG. 7). The curved surface 54a deforms the conductor crimp pieces 41 into a curved shape such that the tip ends of the pair of conductor crimp pieces 41 and 41 are directed to the first mold 51. As illustrated in FIG. 11, the first crimper 54 deforms the conductor crimp pieces 41 such that the conductor 21 is wrapped by the pair of conductor crimp pieces 41 and 41 and the bottom plate 30.

As illustrated in FIG. 12, the second crimper 55 has a curved surface 55a that deforms the pair of insulator crimp pieces 42 and 42. The insulator crimp portion 34 of the present embodiment is crimped to the insulator 22 in a manner called D-crimp (see FIG. 8). The curved surface 55a deforms the insulator crimped pieces 42 into a curved shape such that the tip ends of the pair of insulator crimp pieces 42 and 42 partially overlap with each other. As illustrated in FIG. 13, the second crimper 55 deforms the insulator crimped pieces 42 such that the insulator 22 is wrapped by the pair of insulator crimped pieces 42 and 42 and the bottom plate 30.

Next, the effect of the crimp terminal 3, and the effect of the method for manufacturing the terminal-equipped wire 1 will be described.

As described above, the crimp terminal 3 according to an aspect of the present embodiment includes the plate-like terminal body (bottom plate 30) on which the wire 2 is disposed. The crimp terminal 3 includes the conductor crimp portion 33 formed in the terminal body and to which the conductor 21 of the wire 2 is crimped, and the insulator crimp portion 34 formed in a portion which is rearward of the conductor crimp portion 33 in the terminal body and to which the insulator 22 of the wire 2 is crimped. The insulator crimp portion 34 includes a pair of crimp pieces (insulator crimp pieces 42 and 42) projecting outward in the width direction from both side edges in the width direction of the terminal body. The front end edges of the crimp pieces (front end edges 42a of the insulator crimp pieces 42) are inclined backward with respect to a direction (up-down direction) orthogonal to the front-rear direction of the terminal body.

When the crimp terminal 3 is crimped to the wire 2, the insulator crimp pieces 42 are pressurized from the second crimper 55, and a force is generated in the direction in which the insulator crimp pieces 42 incline toward the conductor crimp portion 33 side in the insulator crimp portion 34 as the crimp terminal 3 (bottom plate 30) elongates (elongation ST: see FIG. 9). In the present embodiment, since the front end edges 42a of the insulator crimp pieces 42 are inclined opposite (backward) to the direction of the force generated in the direction in which the insulator crimp pieces 42 incline toward the conductor crimp portion 33 side, thereby making it difficult for the insulator crimp pieces 42 to incline toward the conductor crimp portion 33. Moreover, even if the insulator crimp pieces 42 have inclined toward the conductor crimp portion 33, the amount of inclination of the insulator crimp pieces 42 can be reduced.

As described above, the present embodiment makes it possible to provide the crimp terminal 3 capable of suppressing an inclination of the insulator crimp pieces 42 toward the conductor crimp portion 33 side when the crimp terminal 3 is crimped to the wire 2.

In the crimp terminal 3 according to an aspect of the embodiment, the rear end edges of the crimp pieces (rear end edges 42b of the insulator crimp pieces 42) may be substantially orthogonal to the front-rear direction of the terminal body (bottom plate 30).

In present embodiment, since the rear end edges 42b of the insulator crimp pieces 42 are substantially orthogonal to the direction of the force generated in the direction in which the insulator crimp pieces 42 incline toward the conductor crimp portion 33 side, even if the insulator crimp pieces 42 have inclined toward the conductor crimp portion 33, the amount of inclination of the insulator crimp pieces 42 can be reduced.

In the method for manufacturing the terminal-equipped wire 1 according to an aspect of the embodiment, the wire 2 includes the conductor 21, and the insulator 22 covering the conductor 21 in a state in which the front end of the conductor 21 is exposed. The crimp terminal 3 includes the plate-like terminal body (bottom plate 30), the conductor crimp portion 33 formed in the terminal body and to which the exposed conductor 21 is crimped, and the insulator crimp portion 34 formed in a portion which is rearward of the conductor crimp portion 33 in the terminal body and to which the front end of the insulator 22 is crimped. The method for manufacturing the terminal-equipped wire 1 includes disposing the wire 2 in the crimp terminal 3, and crimping the conductor crimp portion 33 to the exposed conductor 21 and crimping the insulator crimp portion 34 to the front end of the insulator 22. The insulator crimp portion 34 includes a pair of crimp pieces (insulator crimp pieces 42 and 42) projecting outward in the width direction from both side edges in the width direction of the terminal body in a state before crimping the insulator crimp portion 34 to the insulator 22. The front end edges of the crimp pieces (front end edges 42a of the insulator crimp pieces 42) are inclined backward with respect to the direction (up-down direction) orthogonal to the extending direction of the wire 2 in a state before crimping the insulator crimp portion 34 to the insulator 22.

When the crimp terminal 3 is crimped to the wire 2, the insulator crimp pieces 42 are pressurized from the second crimper 55, and a force is generated in the direction in which the insulator crimp pieces 42 incline toward the conductor crimp portion 33 side in the insulator crimp portion 34 as the crimp terminal 3 (bottom plate 30) elongates (elongation ST: see FIG. 9). In the present embodiment, since the front end edges 42a of the insulator crimp pieces 42 are inclined opposite (backward) to the direction of the force generated in the direction in which the insulator crimp pieces 42 incline toward the conductor crimp portion 33 side, thereby making it difficult for the insulator crimp pieces 42 to incline toward the conductor crimp portion 33. Moreover, even if the insulator crimp pieces 42 have inclined toward the conductor crimp portion 33, the amount of inclination of the insulator crimp pieces 42 can be reduced.

As described above, the present embodiment makes it possible to provide the terminal-equipped wire 1 capable of suppressing an inclination of the insulator crimp pieces 42 toward the conductor crimp portion 33 side when the crimp terminal 3 is crimped to the wire 2.

In the method for manufacturing the terminal-equipped wire 1 according to an aspect of the embodiment, the rear end edges of the crimp pieces (rear end edges 42b of the insulator crimp pieces 42) may be substantially orthogonal to the extending direction of the wire 2 in a state before crimping the insulator crimp portion 34 to the insulator 22.

In present embodiment, since the rear end edges 42b of the insulator crimp pieces 42 are substantially orthogonal to the direction of the force generated in the direction in which the insulator crimp pieces 42 incline toward the conductor crimp portion 33 side, even if the insulator crimp pieces 42 have inclined toward the conductor crimp portion 33, the amount of inclination of the insulator crimp pieces 42 can be reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A crimp terminal comprising:
a plate-like terminal body on which a wire is disposed;
a conductor crimp portion formed in the terminal body and to which a conductor of the wire is crimped; and
an insulator crimp portion formed in a portion which is rearward of the conductor crimp portion in the terminal body and to which an insulator of the wire is crimped, wherein
the insulator crimp portion includes a pair of crimp pieces projecting outward in a width direction from both side edges in the width direction of the terminal body, and
front end edges of the crimp pieces are inclined backward with respect to a direction orthogonal to a front-rear direction of the terminal body.

2. The crimp terminal according to claim 1,
wherein rear end edges of the crimp pieces are substantially orthogonal to the front-rear direction of the terminal body.

3. A method for manufacturing a terminal-equipped wire comprising:
disposing a wire in a crimp terminal, the wire including: a conductor; and an insulator covering the conductor in a state in which a front end of the conductor is exposed, and the crimp terminal including: a plate-like terminal body; a conductor crimp portion formed in the terminal body and to which the exposed conductor is crimped; and an insulator crimp portion formed in a portion which is rearward of the conductor crimp portion in the terminal body and to which a front end of the insulator is crimped; and
crimping the conductor crimp portion to the exposed conductor and crimping the insulator crimp portion to the front end of the insulator, wherein
the insulator crimp portion includes a pair of crimp pieces projecting outward in a width direction from both side edges in the width direction of the terminal body in a state before crimping the insulator crimp portion to the insulator, and
front end edges of the crimp pieces are inclined backward in a direction orthogonal to an extending direction of the wire in a state before crimping the insulator crimp portion to the insulator.

4. The method for manufacturing the terminal-equipped wire according to claim 3,
wherein rear end edges of the crimp pieces are substantially orthogonal to the extending direction of the wire in a state before crimping the insulator crimp portion to the insulator.
